(19) United States
(12) Patent Application Publication
(10) Pub. No.: US 2014/0157613 A1
(43) Pub. Date: Jun. 12, 2014

(54) FAN ASSEMBLY FOR AN APPLIANCE

(71) Applicant: GENERAL ELECTRIC COMPANY, Schenectady, NY (US)

(72) Inventor: Joseph Lee McLain, Louisville, KY (US)

(73) Assignee: GENERAL ELECTRIC COMPANY, Schenectady, NY (US)

(21) Appl. No.: 13/711,672

(22) Filed: Dec. 12, 2012

(51) Int. Cl. F04D 3/00; F26B 11/02

(52) U.S. Cl. CPC F04D 3/00; F26B 11/028
USPC 34/139; 416/198 R

(57) ABSTRACT

A fan assembly for an appliance is provided. The fan assembly includes a first plurality of blades and a second plurality of blades. Performance of the appliance can be improved and uniform fan assembly performance over a wide range of pressures can be provided by including the first and second pluralities of blades.

### FIELD OF THE INVENTION

The present subject matter relates generally to fan assemblies for appliances, e.g., dryer appliances.

### BACKGROUND OF THE INVENTION

Dryer appliances generally include a cabinet with a drum rotatably mounted therein. A motor can selectively rotate the drum during operation of the dryer appliance, e.g., to tumble articles located within a chamber defined by the drum. Dryer appliances also generally include a heater assembly that passes heated air through the chamber of the drum in order to dry moisture laden articles disposed within the chamber. To circulate heated air, the heater assembly can include a fan. The fan can be rotated by the motor that also rotates the drum.

During operation of the dryer appliance, the fan of the heater assembly can urge a flow of heated air into the chamber of the drum. Such heated air can absorb moisture from articles disposed within the chamber. In turn, the fan can urge moisture laden air out of the chamber through a vent. The vent can be connected to household ductwork that directs the moisture laden air outdoors.

Performance of a dryer appliance can be affected by the flow of heated air. For example, dryer appliance performance can be improved by generating a large volume of heated air. Conversely, dryer appliance performance can be negatively affected if the heating assembly generates a low volume of heated air.

In addition, performance of the dryer appliance can decrease over time. For example, lint can accumulate within the dryer appliance's vent or within the household ductwork, e.g., because owners rarely clean the vent and/or ductwork. Such lint can hinder or resist the flow of heated air and thereby negatively affect dryer appliance performance, e.g., leading to increased drying time.

Accordingly, a dryer appliance with features for improving air flow through the dryer appliance would be useful. In particular, a dryer appliance with features for providing uniform performance over a wide range of pressures would be useful.

To improve dryer performance, certain dryer appliances include a second motor. The second motor is configured to rotate the heater assembly's fan. In particular, the second motor rotates the fan rather than the motor that rotates the drum. Thus, the drum and fan are able to rotate independently. Further, the rotational speed of the fan can be adjusted with the second motor, e.g., to maintain the flow of heated air despite lint buildup and thereby improve dryer appliance performance.

However, adding a second motor to a dryer appliance is expensive. Thus, adding the second motor can increase the cost of the dryer appliance and negatively affect a consumer's desire to purchase the dryer appliance. Accordingly, a dryer appliance with features for improving air flow through the dryer appliance without adding a second motor to the dryer appliance would be useful. In particular, a dryer appliance with features for providing uniform performance over a wide range of pressures without adding a second motor to the dryer appliance would be useful.

### BRIEF DESCRIPTION OF THE INVENTION

The present subject matter provides a fan assembly for an appliance. The fan assembly includes a first plurality of blades and a second plurality of blades. Performance of the appliance can be improved and uniform fan assembly performance over a wide range of pressures can be provided by including the first and second pluralities of blades. Additional aspects and advantages of the invention will be set forth in part in the following description, or may be apparent from the description, or may be learned through practice of the invention.

In a first exemplary embodiment, a dryer appliance is provided. The dryer appliance includes a cabinet. The cabinet defines a vent. A drum is rotatably mounted within the cabinet. The drum defines a chamber for receipt of articles for drying. A conduit connects the chamber of the drum and the vent of the cabinet such that the chamber of the drum and the vent of the cabinet are in fluid communication. A motor is also included. A fan is in fluid communication with the conduit. The fan has an axis of rotation about which the fan is rotatable. The fan is in mechanical communication with the motor. The fan is rotatable about the axis of rotation by the motor in order to urge a flow of air from the chamber of the drum to the vent of the cabinet through the conduit. The fan defines a radial direction, a circumferential direction, and an axial direction. The fan includes a support having a first surface and a second surface. The first surface of the support is spaced apart from the second surface of the support along the axial direction. A first plurality of blades is mounted on the first surface of the support and extends away from the first surface of the support. A second plurality of blades is mounted on the second surface of the support and extends away from the second surface of the support.

In a second exemplary embodiment, a dryer appliance is provided. The dryer appliance includes a cabinet. The cabinet defines a vent. A drum is rotatably mounted within the cabinet. The drum defines a chamber for receipt of articles for drying. A conduit connects the chamber of the drum and the vent of the cabinet. The conduit places the chamber of the drum and the vent of the cabinet in fluid communication. A motor is in mechanical communication with the drum such that the motor selectively rotates the drum. A fan is disposed within the conduit. The fan has an axis of rotation about which the fan is rotatable. The fan is in mechanical communication with the motor. The fan is rotatable about the axis of rotation by the motor in order to urge a flow of air from the chamber of the drum to the vent of the cabinet through the conduit. The fan defines a radial direction, a circumferential direction, and an axial direction. The fan includes a base coupled to the motor. An annular plate is spaced apart from the base along the axial direction. The annular plate has a first surface and a second surface. The first surface of the annular plate is spaced apart from the second surface of the annular plate along the axial direction. A plurality of low pressure blades is mounted on the first surface of the annular plate and extends away from the first surface of the plate along the axial direction. A plurality of high pressure blades is mounted on the second surface of the annular plate and extends between and connects the annular plate and the base.

In a third exemplary embodiment, a fan assembly for an appliance is provided. The fan assembly defines a radial direction, a circumferential direction, and an axial direction. The fan assembly includes an annular plate. The annular plate has a first surface and a second surface. The first surface of the annular plate is spaced apart from the second surface of the annular plate along the axial direction. A plurality of low pressure blades is mounted on the first surface of the annular plate and extends away from the first surface of the annular plate along the axial direction. A plurality of high pressure blades is mounted on the second surface of the annular plate and extends away from the second surface of the annular plate along the axial direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of a dryer appliance according to an exemplary embodiment of the present subject matter. The dryer appliance includes a cabinet.

FIG. 2 provides a perspective view of the dryer appliance of FIG. 1 with a portion of the cabinet removed to reveal internal components of the dryer appliance. In particular, a fan assembly according to an exemplary embodiment of the present subject matter is revealed.

FIG. 3 provides a perspective view of the fan assembly of FIG. 2. The fan assembly is removed from the dryer appliance.

FIG. 4 is a top, plan view of the fan assembly of FIG. 3.

FIG. 5 is a side, elevation view of the fan assembly of FIG. 3.

FIG. 6 is a top, plan view of a plurality of high pressure blades of the fan assembly of FIG. 3 according to an exemplary embodiment of the present subject matter.

FIG. 7 is a top, plan view of a plurality of low pressure blades of the fan assembly of FIG. 3 according to an exemplary embodiment of the present subject matter.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term “article” may refer to but need not be limited to fabrics, textiles, garments (or clothing), and linens. Furthermore, the term “load” or “laundry load” refers to the combination of articles that may be washed together in a washing machine or dried together in a laundry dryer (i.e., a clothes dryer) and may include a mixture of different or similar articles of different or similar types and kinds of fabrics, textiles, garments and linens within a particular laundering process.

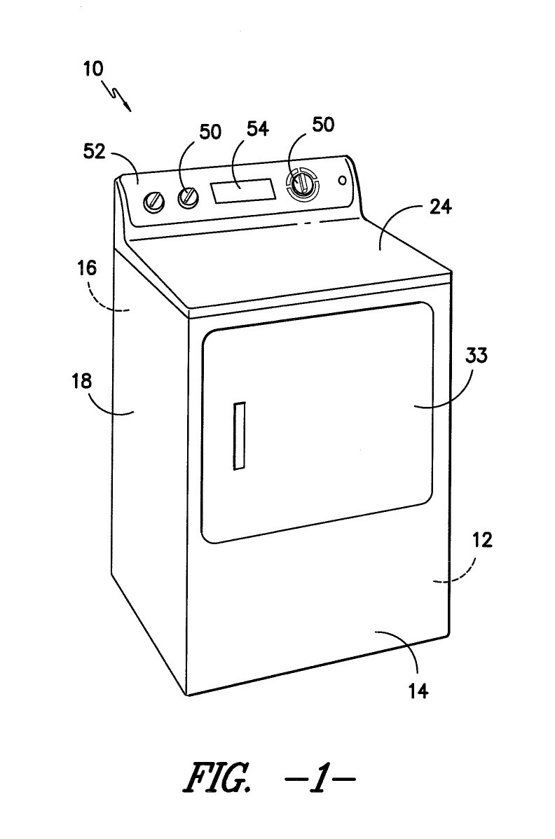

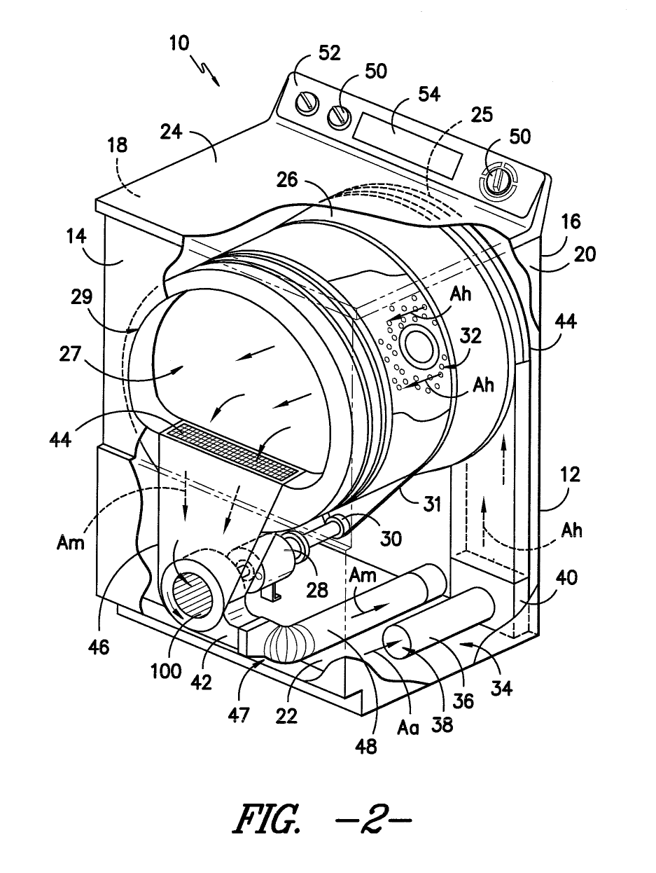

FIGS. 1 and 2 illustrate a dryer appliance 10 according to an exemplary embodiment of the present subject matter. While described in the context of a specific embodiment of dryer appliance 10, using the teachings disclosed herein it will be understood that dryer appliance 10 is provided by way of example only. Other dryer appliances having different appearances and different features may also be utilized with the present subject matter as well. For example, dryer appliance 10 illustrated in FIGS. 1 add 2 is a gas dryer appliance with a combustion chamber 36. In alternative exemplary embodiments, dryer appliance 10 may be an electric dryer appliance with electric heating elements replacing combustion chamber 36.

Dryer appliance 10 includes a cabinet 12 having a front panel 14, a rear panel 16, a pair of side panels 18 and 20 spaced apart from each other by front and rear panels 14 and 16, a bottom panel 22, and a top cover 24. Within cabinet 12 is a drum or container 26 mounted for rotation about a substantially horizontal axis. Drum 26 is generally cylindrical in shape and defines a chamber 27 for receipt of articles for drying.

Drum 26 also defines an opening 29 for permitting access to the chamber 27 of drum 26. Opening 29 of drum 26, e.g., permits loading and unloading of clothing articles and other fabrics from chamber 27 of drum 26. A door 33 is rotatably mounted at opening 29 and selectively hinders access to chamber 27 of drum 26 through opening 29.

Drum 26 includes a rear wall 25 rotatably supported within cabinet 12 by a suitable fixed bearing. Rear wall 25 can be fixed or can be rotatable. A motor 28 rotates the drum 26 about the horizontal axis through a pulley 30 and a belt 31. Motor 28 is also in mechanical communication with an air handler 42 such that motor 28 rotates a fan assembly 100, e.g., a centrifugal fan assembly, of air handler 42. Air handler 42 is configured for drawing air through chamber 27 of drum 26, e.g., in order to dry articles located therein as discussed in greater detail below. In alternative exemplary embodiments, dryer appliance 10 may include an additional motor (not shown) for rotating fan assembly 100 of air handler 42 independently of drum 26.

Drum 26 is configured to receive heated air that has been heated by a heater assembly 34, e.g., in order to dry damp articles disposed within chamber 27 of drum 26. Heater assembly 34 includes a combustion chamber 36. As discussed above, during operation of dryer appliance 10, motor 28 rotates drum 26 and fan assembly 100 of air handler 42 such that air handler 42 draws air through chamber 27 of drum 26 when motor 28 rotates fan assembly 100. In particular, ambient air, shown with arrow Aₐ, enters combustion chamber 36 via an inlet 38 due to air handler 42 urging such ambient air Aₐ into inlet 38. Such ambient air Aₐ is heated within combustion chamber 36 and exits combustion chamber 36 as heated air, shown with arrow Aₕ. Air handler 42 draws such heated air Aₕ through a back duct 40 to drum 26. The heated air Aₕ enters drum 26 through a plurality of holes 32 defined in rear wall 25 of drum 26.

Within chamber 27, the heated air Aₕ can accumulates moisture, e.g., from damp articles disposed within chamber 27. In turn, air handler 42 draws moisture laden air, shown as arrow Aₘ, through a screen filter 44 which traps lint particles. Such moisture laden air Aₘ then enters a front duct 46 and is passed through air handler 42 to an exhaust duct 48. From exhaust duct 48, such moisture laden air Aₘ passes out of clothes dryer 10 through a vent 49 defined by cabinet 12.

Front duct 46 and exhaust duct 48 form a conduit 47 that extends between and connects chamber 27 of drum 26 and vent 49. Conduit 47 places chamber 27 of drum 26 and vent 49 in fluid communication in order to permit moisture laden air Aₘ to exit dryer appliance 10. Air handler 42 is in fluid communication with conduit 47, and fan assembly 100 of air handler 42 is positioned within conduit 47.

A cycle selector knob 50 is mounted on a cabinet backsplash 52 and is in communication with a controller 54. Signals generated in controller 54 operate motor 28 and heater assembly 34 in response to a position of selector knob 50. Alternatively, a touch screen type interface may be provided. As used herein, “processing device” or “controller” may refer to one or more microprocessors or semiconductor devices and is not restricted necessarily to a single element. The processing device can be programmed to operate dryer appliance 10. The processing device may include, or be associated with, one or memory elements such as e.g., electrically erasable, programmable read only memory (EEPROM).

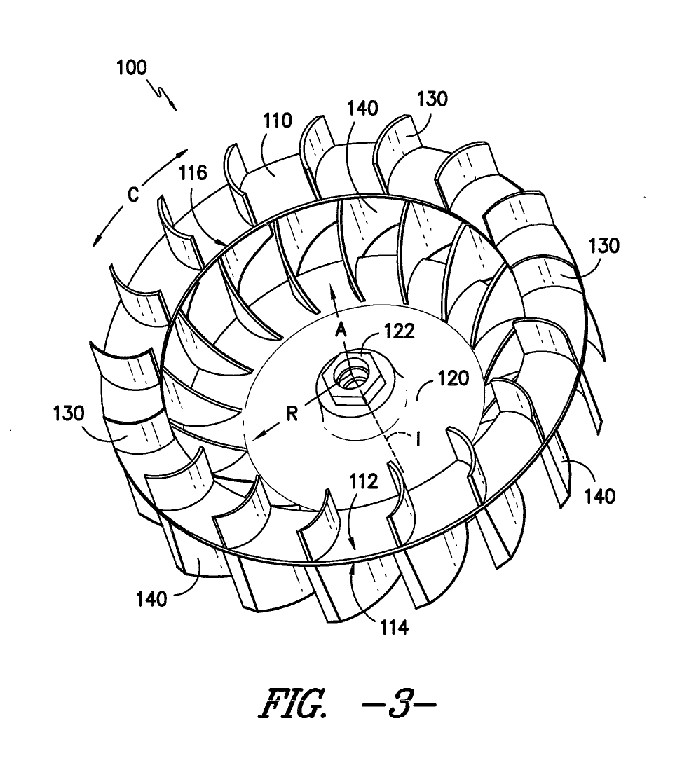

FIG. 3 provides a perspective view of fan assembly 100. In FIG. 3, fan assembly 100 is removed from dryer appliance 10 and air handler 42. As may be seen in FIG. 3, fan assembly 100 has an axis of rotation I about which fan assembly 100 is rotatable, e.g., by motor. Fan assembly 100 also defines a radial direction R, a circumferential direction C, and an axial direction A. It should be understood that fan assembly 100 may be used in dryer appliance 10 and/or any other suitable appliance, e.g., a convection oven, a dishwasher appliance, and/or a refrigerator appliance.

Fan assembly 100 has an annulus or support 110. In FIG. 3, support 110 is shown as an arcuate plate such that support 110 defines an opening 116. However, in alternative exemplary embodiments, support 110 may have any suitable shape, e.g., a circular disc. Support 110 has opposing surfaces, shown in the exemplary embodiments of FIG. 3 as a first surface 112 and a second surface 114. First surface 112 of support 110 is spaced apart from second surface 114 of support 100 along the axial direction A. First surface 112 may be positioned axially, upstream of second surface 114 relative to a flow of air from chamber 27 of drum 26 to vent 49, e.g., moisture laden air Aₘ. Thus, first surface 112 is an axial, upstream surface of support 110, and second surface 114 is an axial, downstream surface of support 110.

Fan assembly 100 also includes a base 120. Base 120 is spaced apart from support 110 of fan assembly 100 along the axial direction A. In FIG. 3, base 120 is shown as a circular plate. However, in alternative exemplary embodiments, base 120 may have any suitable shape, e.g., an annular disc. A coupling 122 is mounted to base 120. Coupling 122 is configured for mounting base 120 and in turn fan assembly 100 to motor 28 (FIG. 2) of dryer appliance 10. For example, coupling 122 may receive a shaft (not shown) of motor 28.

Fan assembly 100 also includes a first plurality of blades 130 and a second plurality of blades 140. First and second plurality of blades 130 and 140 may be forward-curved, backward-curved, radial, or airfoil-shaped. First plurality of blades 130 is mounted on first surface 112 of support 110. Similarly, second plurality of blades 140 is mounted on second surface 114 of support 110. First plurality of blades 130 extends away from first surface 112 of support 110 along the axial direction A. Similarly, second plurality of blades 140 extends away from second surface 114 of support 110 along the axial direction A. In addition, second plurality of blades 140 extend between and connect base 120 and support 110.

Referencing both FIG. 2 and FIG. 3, first surface 112 of support 110 may be positioned upstream of second surface 114 of support 110 relative to a flow of air from chamber 27 of drum 26 to vent 49, e.g., moisture laden air Aₘ. Thus, flow of air from chamber 27 of drum 26 to vent 49 may encounter first plurality of blades 130 before second plurality of blades 140 within conduit 47. Opening 116 between first surface 112 and second surface 114 of support 110 may permit flow of air from chamber 27 of drum 26 to vent 49 to pass through support 110 and thus from first plurality of blades 130 to second plurality of blades 140 as discussed in greater detail below.

FIG. 4 is a top, plan view of fan assembly 100. As may be seen in FIG. 4, first plurality of blades 130 is uniformly distributed on the first surface 112 of support 110 along the circumferential direction C. Similarly, second plurality of blades 140 is uniformly distributed on the second surface 114 of support 110 along the circumferential direction C.

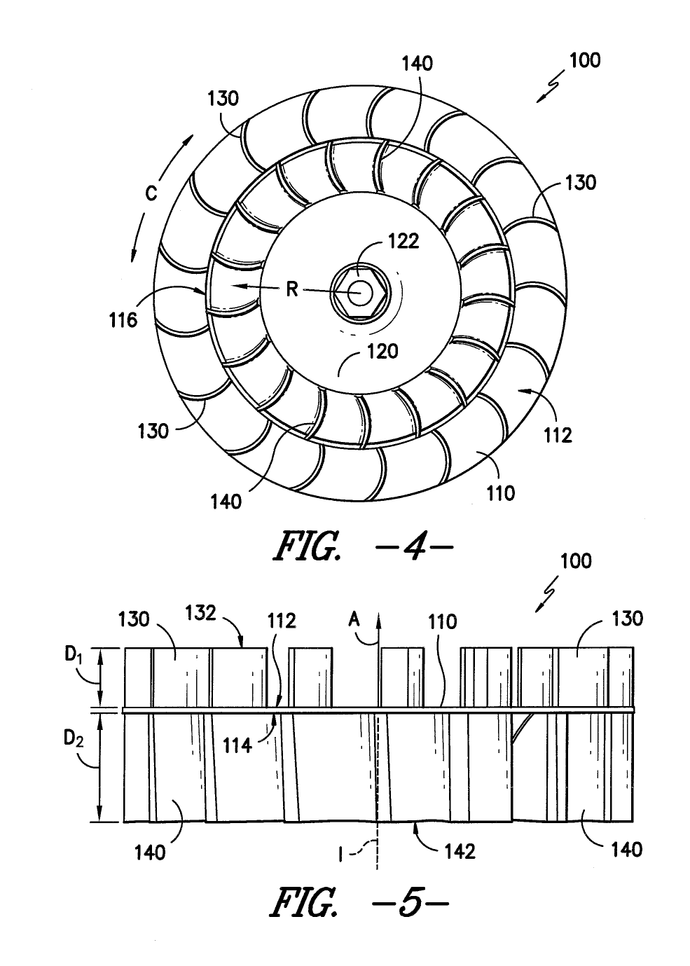

FIG. 5 is a side, elevation view of fan assembly 100. As may be seen in FIG. 5, first plurality of blades 130 is mounted on first surface 112 of support 100 and extends away from first surface 112 along the axial direction A. In particular, each blade of first plurality of blades 130 has a distal end 132 that is spaced apart from first surface 112 of support 110 by about a first distance D₁. Similarly, second plurality of blades 140 is mounted on second surface 114 of support 110 and extends away from second surface 114 of support 110. In particular, each blade of second plurality of blades 140 has a distal end 122 that is spaced apart from second surface 114 of support 110 by about a second distance D₂.

In FIG. 5, the first distance D₁ is different than the second distance D₂. In particular, the first distance D₁ is less than the second distance D₂. However, in alternative exemplary embodiments, the first distance D₁ may be greater than or equal to the second distance D₂.

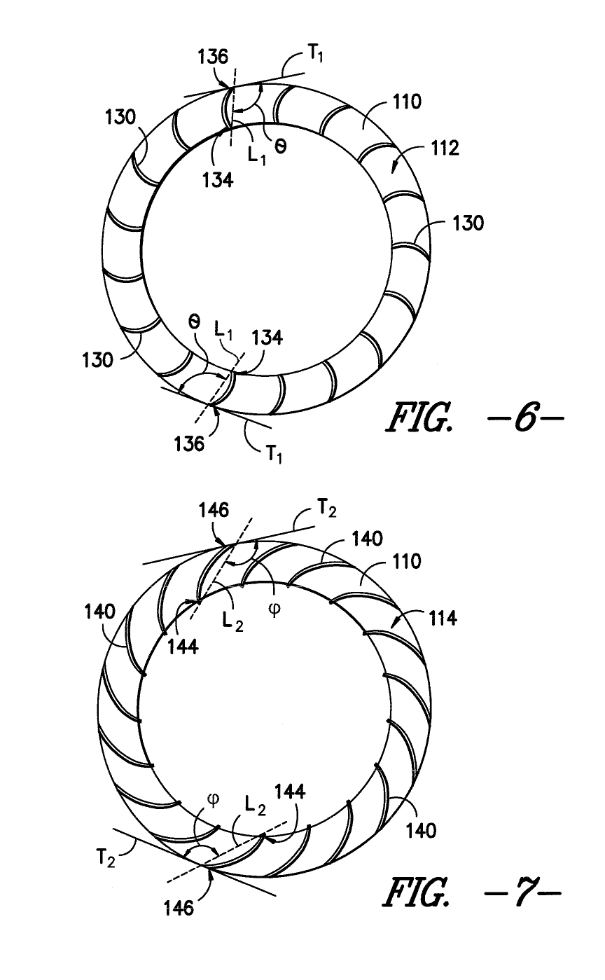

FIG. 6 is a top, plan view of first plurality of blades 130 of fan assembly 100 according to an exemplary embodiment of the present subject matter. FIG. 7 is a top, plan view of second plurality of blades 140 of fan assembly 100 according to an exemplary embodiment of the present subject matter. As may be seen in FIG. 6, each blade of first plurality of blades 130 has a leading portion 134 and a trailing portion 136. In addition, each blade of first plurality of blades 130 defines a first chord line L₁ between the leading portion 134 and the trailing portion 136. Each blade of first plurality of blades 130 also defines an angle θ between a first tangent line T₁ and the first chord line L₁. First tangent line T₁ is defined by support 110 relative to the circumferential direction C at each trailing portion 136 of first plurality of blades 130.

Similarly, as may be seen in FIG. 7, each blade of second plurality of blades 140 has a front portion 144 and a back portion 146. In addition, each blade of second plurality of blades 140 defines a second chord line L₂ between the front portion 144 and the back portion 146. Each blade of second plurality of blades 140 also defines an angle φ between a second tangent line T₂ and the second chord line L₂. Second tangent line T₂ is defined by support 110 relative to the circumferential direction C at each back portion 146 of second plurality of blades 140.

As may be seen in FIGS. 6 and 7, the angle θ is different than the angle φ. In particular, the angle θ is less than the angle φ. However, in alternative exemplary embodiments, the angle θ may be greater than or equal to the angle φ.

By providing fan assembly 100 with first and second pluralities 130 and 140, performance of dryer appliance 10 can be improved. In particular, first plurality of blades 130 can be configured as a plurality of low pressure blades, and second plurality of blades 140 can be configured as a plurality of high pressure blades. In such a configuration, first plurality of blades 130 is configured for operating when the dryer appliance 10 sees relatively low resistance to airflow. For example, the resistance to airflow would be low when dryer appliance 10 contains a small load of articles or when ductwork within the house containing dryer appliance 10 is new or recently cleaned. Thus, first plurality of blades 130 may operate when moisture laden air Aₘ exiting vent 49 is unimpeded by lint buildup. Conversely, second plurality of blades 140 can be configured for operating when the dryer appliance 10 sees relatively high resistance to airflow. For example, the resistance to airflow would be high when dryer appliance 10 contains a large load of articles or when lint builds up within ductwork of the house containing dryer appliance 10. Thus, second plurality of blades 140 may operate when moisture laden air Aₘ exiting vent 49 is impeded by lint buildup.

In such a configuration fan assembly 100 may operate efficiently at both relatively low and high pressures. In particular, by having two pluralities of blades, each optimized for a different range of pressure, the fan assembly 100 can operate effectively over a larger total range of pressure relative to a fan assembly with a single plurality of blades optimized for a single range of pressure.

As an example, during operation of dryer appliance 10, motor 28 may rotate fan assembly 100 within air handle 42 in order to initiate the flow of air from chamber 27 of drum 26 to vent 49 within conduit 47, e.g., moisture laden air Aₘ. When ductwork within the house containing dryer appliance 10 is newly cleaned, moisture laden air Aₘ may engage first plurality of blades 130 because dryer appliance 10 is operating with relatively low resistance to airflow. However, over time, lint can accumulate within the ductwork and restrict the flow of air within conduit 47. As the restriction increases, the flow of air will bypass the first plurality of blades 130 since they are becoming less effective. The flow of air will pass through the opening 116 of support 110 to the second plurality of blades 140 that are designed to be more capable of producing the pressure needed to overcome the higher resistance.

As will be understood by those skilled in the art and as may be seen in FIGS. 3-5, fan assembly 100 may be designed such that fan assembly 100 is manufactured with a single pull injection molding process, e.g., fan assembly 100 may have no undercuts. By designing fan assembly 100 in such a manner, the cost of manufacturing fan assembly 100 can be reduced while also providing fan assembly 100 with features that permit fan assembly 100 to be effective over a larger total range of pressure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dryer appliance comprising:
a cabinet, said cabinet defining a vent;
a drum rotatably mounted within said cabinet, said drum defining a chamber for receipt of articles for drying;
a conduit that connects the chamber of said drum and the vent of said cabinet such that the chamber of said drum and the vent of said cabinet are in fluid communication;
a motor;
a fan assembly in fluid communication with said conduit, said fan assembly having an axis of rotation about which said fan assembly is rotatable, said fan assembly being in mechanical communication with said motor; said fan assembly rotatable about the axis of rotation by said motor in order to urge a flow of air from the chamber of said drum to the vent of said cabinet through said conduit, said fan assembly defining a radial direction, a circumferential direction, and an axial direction; said fan assembly comprising:
a support having a first surface and a second surface, the first surface of said support spaced apart from the second surface of said support along the axial direction;
a first plurality of blades mounted on the first surface of said support and extending away from the first surface of said support; and
a second plurality of blades mounted on the second surface of said support and extending away from the second surface of said support.

2. The dryer appliance of claim 1, wherein each blade of said first plurality of blades has a distal end that is spaced apart from the first surface of said support by about a first distance, wherein each blade of said second plurality of blades has a distal end that is spaced apart from the second surface of said support by about a second distance, wherein the first distance is different than the second distance.

3. The dryer appliance of claim 2, wherein the first distance is less than the second distance.

4. The dryer appliance of claim 1, wherein each blade of said first plurality of blades has a leading portion and a trailing portion, each blade of said first plurality of blades defining a first chord line between the leading portion and the trailing portion, said support defining a first tangent line relative to the circumferential direction at each trailing portion of said first plurality of blades, each blade of said first plurality of blades also defining an angle θ between the first tangent line and the first chord line, wherein each blade of said second plurality of blades has front portion and a back portion, each blade of said second plurality of blades defining a second chord line between the front portion and the back portion, said support defining a second tangent line relative to the circumferential direction at each back portion of said second plurality of blades, each blade of said second plurality of blades also defining an angle φ between the second tangent line and the second chord line, wherein the angle θ is different than the angle φ.

5. The dryer appliance of claim 4, wherein the angle θ is less than the angle φ.

6. The dryer appliance of claim 1, wherein said first plurality of blades is positioned upstream of said second plurality of blades relative to the flow of air from the chamber of said drum to the vent of said cabinet.

7. The dryer appliance of claim 1, wherein said support defines an opening between the first surface of said support and the second surface of said support, the opening of said support permitting the flow of air from the chamber of said drum to the vent of said cabinet to pass through said support from said first plurality of blades to said second plurality of blades.

8. The dryer appliance of claim 1, wherein said fan assembly further comprises a base, said second plurality of blades extending between and connecting said base and said support.

9. The dryer appliance of claim 8, wherein said base is mounted to said motor.

10. The dryer appliance of claim 1, wherein said first plurality of blades is uniformly distributed on the first surface of said support along the circumferential direction, wherein said second plurality of blades is uniformly distributed on the second surface of said support along the circumferential direction.

11. The dryer appliance of claim 1, wherein said motor is in mechanical communication with said drum and is configured for rotating said drum.

12. A dryer appliance comprising:
a cabinet, said cabinet defining a vent;
a drum rotatably mounted within said cabinet, said drum defining a chamber for receipt of articles for drying;
a conduit that connects the chamber of said drum and the vent of said cabinet, said conduit placing the chamber of said drum and the vent of said cabinet in fluid communication;
a motor in mechanical communication with said drum such that said motor selectively rotates said drum;
a fan assembly disposed within said conduit, said fan assembly having an axis of rotation about which said fan assembly is rotatable, said fan assembly rotatable about the axis of rotation by said motor in order to urge a flow of air from the chamber of said drum to the vent of said cabinet through said conduit, said fan assembly defining a radial direction, a circumferential direction, and an axial direction; said fan assembly comprising:
a base coupled to said motor;
an annular plate spaced apart from said base along the axial direction, said annular plate having a first surface and a second surface, the first surface of said annular plate opposing the second surface of said annular plate;
a plurality of low pressure blades mounted on the first surface of said annular plate and extending away from the first surface of said annular plate along the axial direction; and
a plurality of high pressure blades mounted on the second surface of said annular plate and extending between and connecting said annular plate and said base.

13. A fan assembly for an appliance, the fan assembly defining a radial direction, a circumferential direction, and an axial direction, the fan assembly comprising:
an annular plate, said annular plate having a first surface and a second surface, the first surface of said annular plate spaced apart from the second surface of said annular plate along the axial direction;
a plurality of low pressure blades mounted on the first surface of said annular plate and extending away from the first surface of said annular plate along the axial direction; and
a plurality of high pressure blades mounted on the second surface of said annular plate and extending away from the second surface of said annular plate along the axial direction.

14. The fan assembly of claim 11, wherein each blade of said plurality of low pressure blades has a distal end that is spaced apart from the first surface of said annular plate along the axial direction by about a first distance, wherein each blade of said plurality of high pressure blades has a distal end that is spaced apart from the second surface of said annular plate along the axial direction by about a second distance, wherein the first distance is different than the second distance.

15. The fan assembly of claim 12, wherein the first distance is less than the second distance.

16. The fan assembly of claim 11, wherein each blade of said plurality of low pressure blades has a leading portion and a trailing portion, each blade of said plurality of low pressure blades defining a low pressure chord line between the leading portion and the trailing portion, said annular plate defining a first tangent line relative to the circumferential direction at each trailing portion of said plurality of low pressure blades, each blade of said plurality of low pressure blades also defining an angle θ between the first tangent line and the low pressure chord line, wherein each blade of said plurality of high pressure blades has front portion and a back portion, each blade of said plurality of high pressure blades defining a high pressure chord line between the front portion and the back portion, said annular plate defining a second tangent line relative to the circumferential direction at each back portion of said plurality of high pressure blades, each blade of said plurality of high pressure blades also defining an angle φ between the second tangent line and the high pressure chord line, wherein the angle θ is different than the angle φ.

17. The fan assembly of claim 14, wherein the angle θ is less than the angle φ.

18. The fan assembly of claim 11, further comprising a base plate spaced apart from said annular plate along the axial direction, said plurality of high pressure blades extending between and connecting said base plate and said annular plate.

19. The fan assembly of claim 11, wherein said plurality of low pressure blades is uniformly distributed on the first surface of said annular plate along the circumferential direction, wherein said plurality of low pressure blades is uniformly distributed on the second surface of said annular plate along the circumferential direction.
